(19) United States
(12) Patent Application Publication
(10) Pub. No.: US 2017/0147230 A1
(43) Pub. Date: May 25, 2017

(54) MEMORY DEVICE AND MEMORY SYSTEM HAVING HETEROGENEOUS MEMORIES

(71) Applicant: SAMSUNG ELECTRONICS CO., LTD., SUWON-SI (KR)

(72) Inventors: YOO-JUNG LEE, JUNG-GU (KR); JU-YUN JUNG, HWASEONG-SI (KR); HYUN-JOONG KIM, HWASEONG-SI (KP); HA-RYONG YOON, SEOUL (KR)

(21) Appl. No.: 15/295,566

(22) Filed: Oct. 17, 2016

(30) Foreign Application Priority Data
Nov. 20, 2015 (KR) 10-2015-0163338

(51) Int. Cl. G06F 3/06

(52) U.S. Cl. CPC G06F 3/0611; G06F 3/0629; G06F 3/0685

(57) ABSTRACT

A memory device includes a first memory having first hardware properties, a second memory having second hardware properties different from the first hardware properties, and a controller configured to receive a signal, representing the first or second hardware properties, with a command to select the first memory or the second memory based on the received signal. The controller controls the selected first or second memory such that an operation according to the command is performed on the selected first or second memory.

### CROSS-REFERENCE TO RELATED APPLICATION

This application claims the benefit of Korean Patent Application No. 10-2015-0163338, filed on Nov. 20, 2015, in the Korean Intellectual Property Office, the disclosure of which is incorporated herein in its entirety by reference.

### BACKGROUND

The disclosure relates to a memory device, and more particularly, to a memory device and a memory system including heterogeneous memories.

A computer system may include various types of memory systems. A memory system includes a memory device storing data and a memory controller controlling an operation of the memory device. A memory is classified into a volatile memory such as a dynamic random access memory (DRAM) or a static RAM (SRAM) memory and a nonvolatile memory such as an electrically erasable programmable read-only memory (EEPROM), a ferroelectric random access memory (FRAM), a phase-change random access memory (PRAM), a magnetic random access memory (MRAM), or a flash memory. Data stored in a volatile memory is lost when a power supply is interrupted. However, data stored in a nonvolatile memory is not lost even when the power supply is interrupted. Recently, a memory module including such heterogeneous memories has been developed. The heterogeneous memories may share a data bus to be connected to a memory controller.

### SUMMARY

According to an aspect of the disclosure, there is provided a memory device including a first memory having first hardware properties, a second memory having second hardware properties different from the first hardware properties, and a controller configured to receive a signal, representing the first or second hardware properties, with a command to select the first memory or the second memory based on the received signal. The controller controls the selected first or second memory such that an operation according to the command is performed on the selected first or second memory.

According to another aspect of the disclosure, there is provided a memory system including a memory device having a first memory with first hardware properties and a second memory with second hardware properties different from the first hardware properties. A memory controller selectively controls the first and second memories by transmitting a signal, representing the first or second hardware properties, and a command together to the memory device.

According to another aspect of the disclosure, there is provided a memory system having a memory device that includes first and second memories. The first memory has a first access latency, and the second memory has a second access latency that differs from the first access latency. A memory controller distinguishes the first memory from the second memory based upon the first and second latencies.

### BRIEF DESCRIPTION OF THE DRAWINGS

Embodiments of the disclosure will be more clearly understood from the following detailed description taken in conjunction with the accompanying drawings in which:

FIG. 1 is a block diagram illustrating a memory system according to an embodiment of the disclosure;

FIG. 2 is a conceptual diagram illustrating an operation of a memory system according to an embodiment of the disclosure;

FIG. 3 is a block diagram illustrating a memory controller according to an embodiment of the disclosure;

FIG. 4 is a block diagram illustrating a memory device according to an embodiment of the disclosure;

FIG. 5 illustrates an example of a latency table of FIG. 3 according to an embodiment of the disclosure;

FIG. 6 is a timing diagram illustrating an example of a read operation of the memory system of FIG. 1 according to an embodiment of the disclosure;

FIGS. 7 and 8 are timing diagrams illustrating examples of a read operation of a memory system according to an embodiment of the disclosure;

FIG. 9 is a flowchart of a method of operating a memory device according to an embodiment of the disclosure;

FIG. 10 is a detailed block diagram illustrating a memory device according to an embodiment of the disclosure;

FIGS. 11A and 11B are block diagrams illustrating a memory system according to embodiments of the disclosure; and

FIG. 12 is a block diagram illustrating a computing system according to an embodiment of the disclosure.

### DETAILED DESCRIPTION OF THE EMBODIMENTS

Hereinafter, embodiments of the disclosure will now be described more fully with reference to the accompanying drawings, in which embodiments of the disclosure are shown. These embodiments are provided so that this disclosure will be thorough and complete and will fully convey the disclosure to those of ordinary skill in the art. The disclosure may, however, be embodied in many different forms and should not be construed as being limited to the embodiments set forth herein. The embodiments should be understood to cover all modifications, equivalents, and alternatives falling within the scope of the disclosure. The same reference numerals represent the same elements throughout the drawings. In the drawings, the sizes of structures may be exaggerated or reduced for clarity.

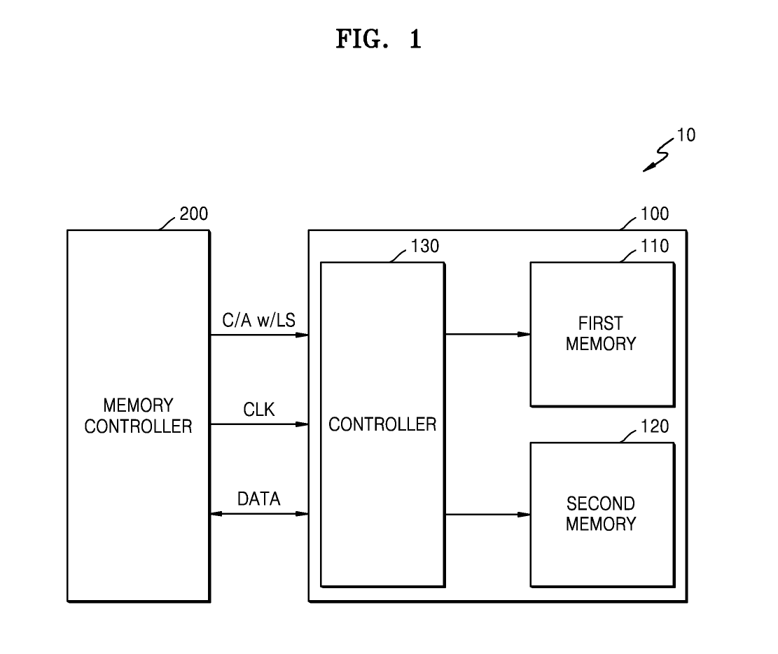

FIG. 1 is a block diagram illustrating a memory system 10 according to an embodiment of the disclosure.

Referring to FIG. 1, the memory system 10 may include a memory device 100 and a memory controller 200. In some embodiments, the memory device 100 may be implemented as a memory module such as a nonvolatile dual in-line memory module (NVDIMM), a load reduced DIMM (LRDIMM), or registered DIMM (RDIMM), and the memory controller 200 may be implemented as a portion of a host. In some embodiments, the memory device 100 and the memory controller 200 may be arranged in a single memory module.

The memory device 100 and the memory controller 200 may be electrically connected to each other via a control bus via which a command/address (C/A) used to direct a data read operation or a data write operation and a clock signal CLK are transmitted and a data bus (i.e., a DQ bus) via which data DATA is transmitted or received. The memory device 100 may include at least first and second memories 110 and 120, and the first and second memories 110 and 120 may share the data bus. Accordingly, the first and second memories 110 and 120 may receive data to be written from the memory controller 200 or transmit read data to the memory controller 200 via the data bus. The number of memories included in the memory device 100 may be various according to embodiments.

According to the present embodiment, the first and second memories 110 and 120 may be heterogeneous memories having different hardware properties. Each of the first and second memories 110 and 120 may be implemented as a memory chip. For example, hardware properties may include a latency, a memory bandwidth, or memory power consumption. The latency may be a read latency, a write latency, a column address strobe (CAS) latency, a row address strobe (RAS) latency or the like.

According to an embodiment, the first memory 110 may have a first read latency, and the second memory 120 may have a second read latency. For example, the first read latency may be shorter than the second read latency, and accordingly, the first memory 110 may operate with a faster response time than the second memory 120. Thus, in order that pieces of data respectively read from the first and second memories 110 and 120 do not collide on the data bus, the first and second memories 10 and 120 are to be individually controlled based on the first and second read latencies that are different from each other.

According to an embodiment, the first memory 110 may be a volatile memory, and the second memory 120 may be a nonvolatile memory. According to an embodiment, the first and second memories 110 and 120 may be volatile memories. According to an embodiment, the first and second memories 110 and 120 may be nonvolatile memories. For example, a volatile memory may include a dynamic random access memory (DRAM), a mobile DRAM, a synchronous DRAM (SDRAM), a double data rate (DDR) DRAM, a low power double data rate (LPDDR) SDRAM, a graphics double data rate (GDDR) SDRAM, a Rambus DRAM (RDRM) or the like. For example, a nonvolatile memory may include a NAND flash memory, a NOR flash memory, a phase-change random access memory (PRAM), a magnetic random access memory (MRAM), a resistive random access memory (ReRAM), a ferroelectric random access memory (FRAM) or the like.

According to an embodiment, the memory device 100 may be a NVDIMM, the first memory 110 may be a volatile memory, and the second memory 120 may be a nonvolatile memory. The memory device 100 may have two operation modes, and may further include emergency power (for example, a capacitor). In a first operation mode, the memory device 100 may operate as a main memory, and the second memory 120, which is nonvolatile, may be used as a backup memory. In detail, when host power is instable, the memory device 100 may perform an operation of backing up data of the first memory 110, which is volatile, to the second memory 120, which is nonvolatile, by using emergency power, thereby preventing loss of data due to failure of host power. In a second operation mode, the memory device 100 may operate as a storage, and the first memory 110, which is volatile, may be used as a buffer memory. A storage capacity of the second memory 120 may be greater than that of the first memory 110.

The memory controller 200 may control the memory device 100 to read data stored in the memory device 100 or write data to the memory device 100 in response to a read or write request from the host. In detail, the memory controller 200 may provide a command/address C/A and a clock signal CLK to the memory device 100 via a control bus to thereby control write, read, and erase operations on the memory device 100. Also, data DATA to be written or data DATA that is read may be transmitted or received between the memory controller 200 and the memory device 100 via a data bus.

According to the present embodiment, the memory controller 200 may transmit to the memory device 100 a latency signal LS indicating a latency value of a memory to be accessed, from among the first and second memories 110 and 120, together with the command/address C/A. In detail, the memory controller 200 may determine a latency signal LS according to a memory to be accessed, on the fly, and may transmit the latency signal LS to the memory device 100 with the command/address C/A. In addition, the memory controller 200 may adjust a time of transmitting a command/address C/A with respect to each of the first and second memories 110 and 120 so as to prevent collision between pieces of data respectively read from the first and second memories 110 and 120 on a data bus, based on a latency value of the memory to be accessed. As described above, according to the present embodiment, efficiency of the data bus may be increased by adaptively controlling an operation on the memory device 100 to different latency values of the first and second memories 110 and 120.

Meanwhile, embodiments of the disclosure are not limited to the latency signal LS, and the memory controller 200 may also provide a predetermined signal indicating hardware properties of a memory to be accessed, from among the first and second memories 110 and 120, together with a command/address C/A, to the memory device 100. For example, the memory controller 200 may transmit a bandwidth signal indicating a bandwidth of a memory to be accessed, from among the first and second memories 110 and 120, to the memory device 100 with a command/address C/A. In detail, the memory controller 200 may determine a bandwidth signal on the fly, based on a memory to be accessed, and transmit the bandwidth signal to the memory device 100 together with a command/address C/A. In addition, the memory controller 200 may adjust a time of transmitting a command/address C/A with respect to each of the first and second memories 110 and 120 so as to prevent collision between pieces of data to be respectively written to the first and second memories 110 and 120 or between pieces of data respectively read from the first and second memories 110 and 120 on a data bus, based on a bandwidth of the memory to be accessed. As described above, according to the present embodiment, efficiency of the data bus may be increased by adaptively controlling an operation on the memory device 100 according to different bandwidths of the first and second memories 110 and 120.

The memory device 100 may further include a controller 130, and the controller 130 may receive a latency signal LS from the memory controller 200 together with a command/address C/A. In detail, the controller 130 may select one of the first and second memories 110 and 120 in response to the latency signal LS, and control a selected memory such that an operation according to the command/address C/A is performed on the selected memory. In some embodiments, the controller 130 may be implemented as an additional chip such as a module control chip. In some embodiments, the controller 130 may be implemented as a portion of an interfacing circuit.

According to the present embodiment, the controller 130 may control an operation on the selected memory by providing the memory, selected based on the latency signal LS, with the command/address C/A. As described above, the memory controller 200 may determine times of transmitting the commands/addresses C/A based on first and second latency values. Accordingly, the controller 130 does not have to additionally adjust times of transmitting pieces of data respectively read from the first and second memories 110 and 120 to a data bus in order to prevent collision between the pieces of data respectively read from the first and second memories 110 and 120 on a data bus.

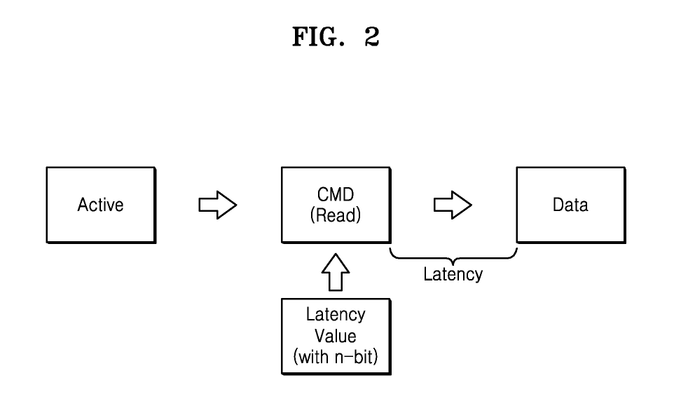

FIG. 2 is a conceptual diagram illustrating an operation of the memory system 10 according to an embodiment of the disclosure.

Referring to FIGS. 1 and 2, the memory controller 200 may transmit an active command to the memory device 100, and the memory device 100 may perform an active operation of activating a row of a predetermined bank in response to the active command. Next, the memory controller 200 may transmit a command CMD (e.g., a read command) and a latency signal LS, indicating a latency value, together to the memory device 100.

According to the present embodiment, the latency signal LS may be determined on the fly based on a memory to be accessed. According to an embodiment, a latency signal LS may be transmitted as a n-bit signal, and may be transmitted to the memory device 100 via n pins of the memory device 100 (n is a natural number). When a latency passes after the memory controller 200 has issued a command CMD, the memory controller 200 may receive data read from the memory device 100 via the data bus.

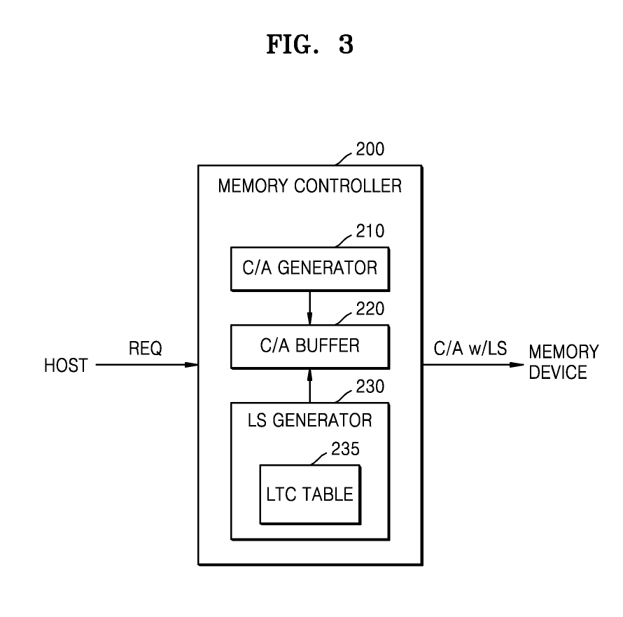

FIG. 3 is a block diagram illustrating a memory controller 200 according to an embodiment of the disclosure.

Referring to FIG. 3, the memory controller 200 may receive a write or read request REQ from a host, and may transmit a command/address C/A and a latency signal LS together to a memory device. The memory controller 200 according to the present embodiment may be an example of the memory controller 200 of FIG. 1, and details described with reference to FIGS. 1 and 2 may apply to the present embodiment.

According to an embodiment, a command/address C/A may include a read command and an address of a memory to be read, and a latency signal LS may indicate a latency value of a memory to be read, from among a plurality of memories included in a memory device. According to an embodiment, a command/address C/A may include a write command and an address of a memory to which data is to be written, and a latency signal LS may indicate a latency value of a memory, to which data is to be written, from among a plurality of memories included in a memory device. According to the present embodiment, the latency signal LS may be transmitted to the memory device as a portion of the command/address C/A.

According to the present embodiment, the memory controller 200 may include a command/address generator 210, a command/address buffer 220, and a latency signal generator 230. The command/address generator 210 may generate a command/address C/A according to a request REQ received from a host. The command/address buffer 220 may buffer the command/address C/A generated by using the command/address generator 210. For example, the command/address buffer 210 may be implemented as a First In First Out (FIFO) buffer. The latency signal generator 230 may refer to a latency table 235 to generate, on the fly, a latency signal LS indicating a latency value of a memory to be accessed.

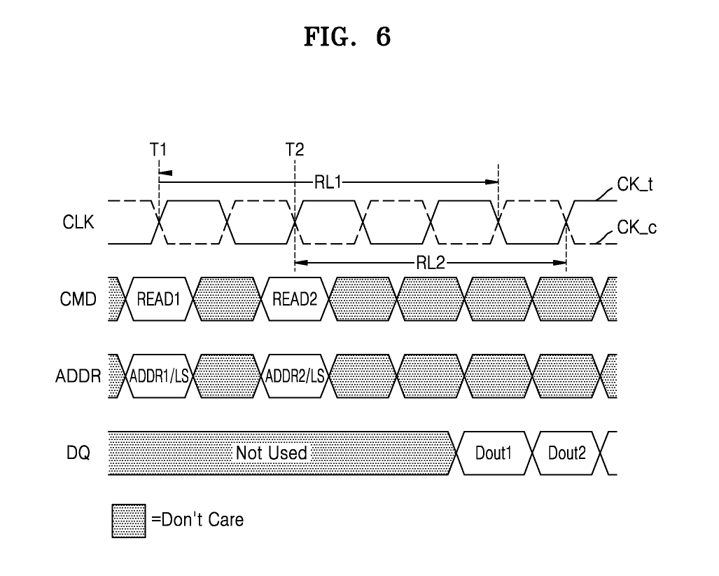

Also, according to the present embodiment, a time of transmitting a command/address C/A may be determined by referring to the latency table 235. In detail, a time of transmitting a command/address C/A may be determined on the fly based on a latency value. In the embodiment of FIG. 1, when the memory controller 200 continuously transmits a command/address C/A to the first and second memories 110 and 120, a time of transmitting a command/address C/A to the first memory 110 (for example, a first time T1 of FIG. 6) and a time of transmitting a command/address C/A to the second memory 120 (for example, a second time T2 of FIG. 6) may be adjusted by referring to latency values respectively corresponding to the first and second memories 110 and 120.

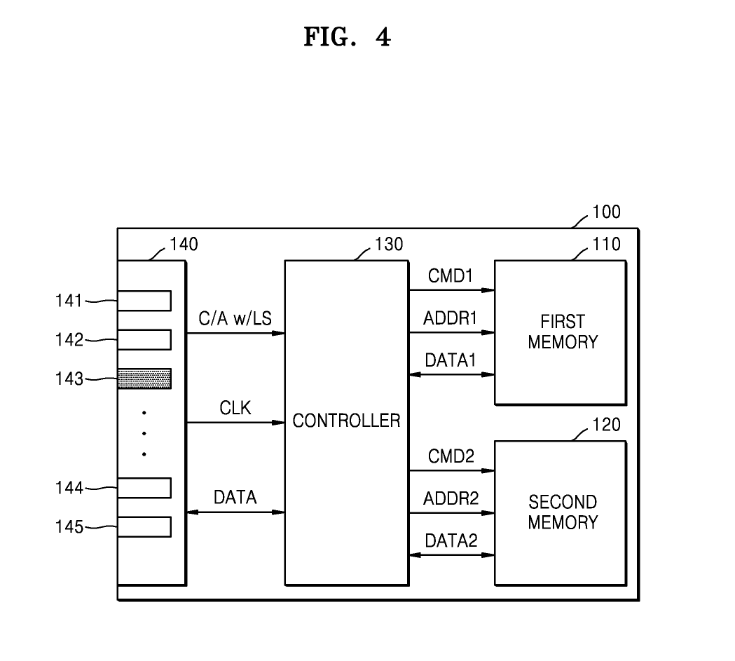

FIG. 4 is a block diagram illustrating a memory device 100 according to an embodiment of the disclosure.

Referring to FIG. 4, the memory device 100 may include first and second memories 110 and 120, a controller 130, and a connector 140. The memory device 100 according to the present embodiment may be an example of the memory device 100 of FIG. 1, and details described with reference to FIGS. 1 and 2 may apply to the present embodiment, and repeated description will be omitted.

The connector 140 may include a plurality of pins 141 through 145 which may include command pins, address pins, data input/output pins, or the like. The number of the plurality of pins 141 through 145 may vary according to a type of the memory device 100. Command pins may receive a command input, and a command input may include, for example, a chip selection signal /CS, a write enable signal /WE, a row address strobe signal /RAS, a column address strobe signal /CAS, or the like. Address pins may receive an address input, and an address input may include a row address RA and a column address CA.

According to the present embodiment, a latency signal LS may be received by the memory device 100 via at least one of the plurality of pins 141 through 145, for example, via the pin 143. In some embodiments, the pin 143 may be one of command pins. In some embodiments, the pin 143 may be one of address pins. In some embodiments, a latency signal LS may be an n-bit signal, and may be received by the memory device 100 via n pins.

The controller 130 may receive a latency signal LS and a command/address C/A, and select one of the first and second memories 110 and 120 based on the latency signal LS. Also, the controller 130 may control a selected memory such that an operation according to the command/address C/A is performed on the selected memory. For example, when the latency signal LS indicates a first latency value corresponding to the first memory 110, the controller 130 may transmit a command CMD1 and an address ADDR1 to the first memory 110, and transmit or receive first data DATA1 to or from the first memory 110. When the latency signal LS indicates a second latency value corresponding to the second memory 120, the controller 130 may transmit a command CMD2 and an address ADDR2 to the second memory 120, and transmit or receive second data DATA2 to or from the second memory 120.

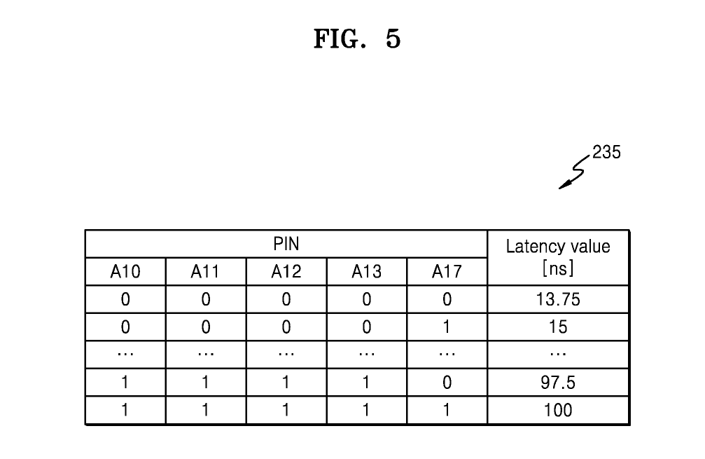

FIG. 5 illustrates an example of the latency table 235 of FIG. 3 according to an embodiment of the disclosure.

Referring to FIG. 5, the latency table 235 may store a plurality of latency values that are different from one another, and the latency values may be represented by n-bit latency signals. The latency table 235 may be updatable and be stored in a nonvolatile memory. According to an embodiment, a latency signal may be a 5-bit signal, and thus may indicate 32 (that is, 2⁵) latency values. For example, when a latency signal is “00000”, a latency value may be 13.75 ns. When a latency signal is “11111,” a latency value may be 100 ns. However, embodiments of the disclosure are not limited thereto, and a latency signal may be a signal with less than 5 bits or a signal with more than 5 bits.

A latency signal may be input to a memory device via address pins (for example, address pins A10, A11, A12, A13, and A17) of a memory device (for example, the memory device 100 of FIG. 1). Hereinafter, the description will be focused on an embodiment in which a latency signal is input to a memory device via address pins of the memory device. However, embodiments of the disclosure are not limited thereto, and a latency signal may also be input to a memory device via other pins of the memory device such as command pins.

FIG. 6 is a timing diagram illustrating an example of a read operation of the memory system 10 of FIG. 1 according to an embodiment of the disclosure.

Referring to FIGS. 1 and 6, a clock signal CLK, a command CMD, an address ADDR, and data DQ may be transmitted between the memory controller 200 and the memory device 100 via a plurality of signal lines. Thus, the first and second memories 110 and 120 included in the memory device 100 may share a data (DQ) bus. According to the present embodiment, a latency value may correspond to a read latency, and the memory controller 200 may provide the memory device 100 with a latency signal LS indicating a first read latency RL1 corresponding to the first memory 110 or a second read latency RL2 corresponding to the second memory 120, together with a command CMD and an address ADDR.

The clock signal CLK may include two differential clocks signals CK_t and CK_c respectively transmitted via two clock signal lines. The command CMD and the address ADDR may be transmitted in synchronization with the clock signal CLK. In detail, the command CMD and the address ADDR may be sampled at a point when a rising edge of the clock signal CK_t and a falling edge of the clock signal CK_c cross each other.

The memory controller 200 may transmit a latency signal LS corresponding to a first read latency RL1 at the first time T1, to the memory device 100, together with a first read command READ1 and a first address ADDR1. For example, the first read latency RL1 may be 15 ns, and the latency signal LS may be “00001.” When the first read latency RL1 passes after the first read command READ1 has been issued, first read data Dout1 may be transmitted from the first memory 110 via the data (DQ) bus.

The memory controller 200 may transmit a latency signal LS corresponding to a second read latency RL2 at the second time T2 to the memory device 100 together with a second read command READ2 and a second address ADDR2. For example, the second read latency RL2 may be 12.5 ns, and the latency signal LS may be “00000.” When the second read latency RL2 passes after the second read command READ2 has been issued, second read data Dout2 may be transmitted from the second memory 120 via the data DQ bus.

The first and second memories 110 and 120, which are different from each other, may share a command (CMD) bus, and first and second read commands READ1 and READ2 respectively regarding the first and second memories 110 and 120 may be provided to the memory device 100 via the command CMD bus. Accordingly, the memory controller 200 may adjust the first and second time T1 and T2 such that no collision occurs between the first and second read commands READ1 and READ2 on the command CMD bus. According to the present embodiment, the memory controller 200 may adjust the first and second times T1 and T2 by referring to a latency table storing latency values.

In addition, the first and second memories 110 and 120, which are different from each other, may share the data DQ bus, and first and second data Dout1 and Dout2 respectively output from the first and second memories 110 and 120 may be provided to the memory controller 200 via the data DQ bus. When the first and second read latencies RL1 and RL2 are different from each other, even when the memory controller 200 provides the first and second read commands READ1 and READ2 at the first and second times T1 and T2, which are different from each other, the first and second data Dout1 and Dout2 may collide with each other on the data DQ bus.

According to the present embodiment, the memory controller 200 may adjust the first and second times T1 and T2 such that the first and second data Dout1 and Dout2 do not collide on the data DQ bus. In detail, the memory controller 200 may adjust the first and second times T1 and T2 such that the first and second data Dout1 and Dout2 are substantially consecutively transmitted via the data DQ bus, that is, such that no idle section is created between the first data Dout1 and the second data Dout2. Accordingly, efficiency of the data DQ bus may be improved.

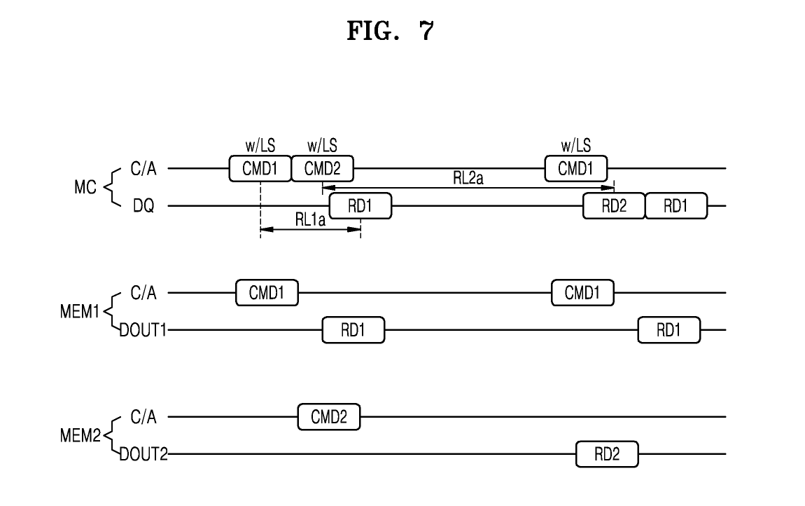

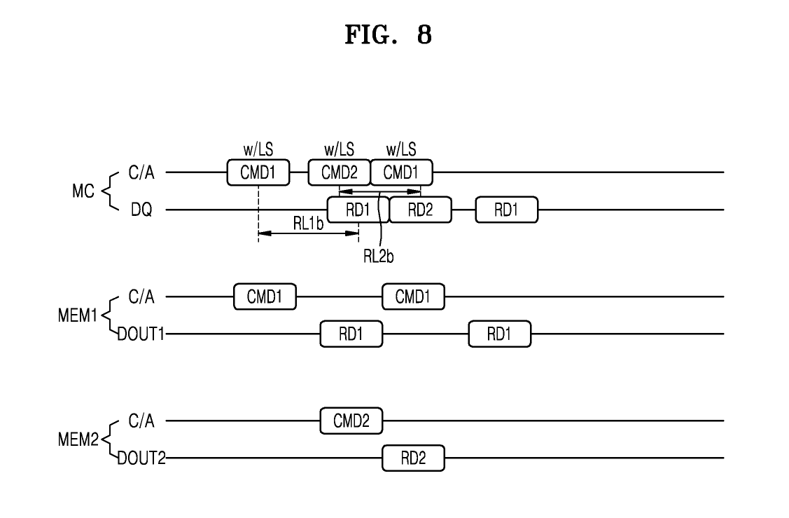

FIGS. 7 and 8 are timing diagrams illustrating examples of a read operation of a memory system according to an embodiment of the disclosure. In FIGS. 7 and 8, a memory controller MC may correspond to, for example, the memory controller 200 of FIG. 1, and a first memory MEM1 may correspond to, for example, the first memory 110 of FIG. 1, and a second memory MEM2 may correspond to, for example, the second memory 120 of FIG. 1. Details described with reference to FIGS. 1 through 6 may apply to the present embodiment.

Referring to FIG. 7, according to the present embodiment, the first memory MEM1 may have a first read latency RL1a, and the second memory MEM2 may have a second read latency RL2a. The second read latency RL2a may be longer than the first read latency RL1a. For example, the first memory MEM1 may be a volatile memory such as a DRAM, and the second memory MEM2 may be a nonvolatile memory, but the embodiments of the disclosure are not limited thereto.

According to the present embodiment, the memory controller MC may provide a latency signal LS to a memory device together with a command. According to an embodiment, a latency signal LS may be input to a memory device via address pins of the memory device. According to an embodiment, a latency signal LS may represent the first read latency RL1a corresponding to the first memory MEM1 or the second read latency RL2a corresponding to the second memory MEM2.

The memory controller MC may transmit the latency signal LS representing the first read latency RL1a to a memory device together with a first command CMD1. The first command CMD1 may be provided to the first memory MEM1 included in the memory device according to the latency signal LS. The first memory MEM1 may receive the first command CMD1 via an internal signal line, and perform a read operation according to the first command CMD1, and provide first read data RD1 via a data input/output line DOUT1.

The memory controller MC may transmit the latency signal LS representing the second read latency RL2a to the memory device together with a second command CMD2. The second command CMD2 may be provided to the second memory MEM2 included in the memory device according to the latency signal LS. The second memory MEM2 may receive the second command CMD2 via an internal signal line, and perform a read operation according to the second command CMD2, and provide second read data RD2 via a data input/output line DOUT2.

The memory controller MC may compare the first and second read latencies RL1a and RL2a by referring to a latency table, and may adjust a time of transmitting the second command CMD2 based on a comparison result. In FIG. 7, as the second read latency RL2a is longer than the first read latency RL1a, the first memory MEM1 may provide the first read data RD1 relatively quickly after receiving the first command CMD1, whereas the second memory MEM2 may provide the second read data RD2 relatively slowly after receiving the second command CMD2. Accordingly, in order to increase an efficiency of the data DQ bus, the memory controller MC may transmit the second command CMD2 relatively quickly after transmitting the first command CMD1 to the memory device. Also, the memory controller MC may adjust a time of transmitting the first command CMD1 after the second command CMD2, such that the first read data RD1 is received as quickly as possible after the second read data RD2 is received via the data DQ bus, and that no collision occurs between the second read data RD2 and the first read data RD1 on the data DQ bus.

Referring to FIG. 8, according to the present embodiment, the first memory MEM1 may have a first read latency RL1b, and the second memory MEM2 may have a second read latency RL2b. The second read latency RL2b may be shorter than the first read latency RL1b. For example, the first memory MEM1 may be a nonvolatile memory, and the second memory MEM2 may be a volatile memory, but the embodiments of the disclosure are not limited thereto.

According to the present embodiment, the memory controller MC may provide a latency signal LS to a memory device together with a command. According to an embodiment, a latency signal LS may be input to a memory device via address pins of the memory device. According to an embodiment, a latency signal LS may represent the first read latency RL1b corresponding to the first memory MEM1 or the second read latency RL2b corresponding to the second memory MEM2.

The memory controller MC may transmit the latency signal LS representing the first read latency RL1b to a memory device together with a first command CMD1. The first command CMD1 may be provided to the first memory MEM1 included in the memory device according to the latency signal LS. The first memory MEM1 may receive the first command CMD1 via an internal signal line, and perform a read operation according to the first command CMD1, and provide first read data RD1 via a data input/output line DOUT1.

The memory controller MC may transmit a latency signal LS representing the second read latency RL2b to the memory device together with a second command CMD2. The second command CMD2 may be provided to the second memory MEM2 included in the memory device according to the latency signal LS. The second memory MEM2 may receive the second command CMD2 via an internal signal line, and perform a read operation according to the second command CMD2, and provide second read data RD2 via a data input/output line DOUT2.

The memory controller MC may compare the first and second read latencies RL1b and RL2b by referring to a latency table, and may adjust a time of transmitting the second command CMD2 based on a comparison result. In FIG. 8, as the second read latency RL2b is shorter than the first read latency RL1b, the first memory MEM1 may provide the first read data RD1 relatively slowly after receiving the first command CMD1, whereas the second memory MEM2 may provide the second read data RD2 relatively quickly after receiving the second command CMD2.

Accordingly, the memory controller MC may transmit the second command CMD2 when a predetermined amount of time passes after transmitting the first command CMD1 to the memory device, such that no collision occurs between the first read data RD1 and the second read data RD2 on the data DQ bus. Also, the memory controller MC may adjust a time of transmitting the first command CMD1 after the second command CMD2, such that the first read data RD1 is received as quickly as possible after the second read data RD2 is received via the data DQ bus, and that no collision occurs between the second read data RD2 and the first read data RD1 on the data DQ bus.

As described above with reference to the examples of FIGS. 7 and 8, according to the present embodiment, heterogeneous memories MEM1 and MEM2 may be individually controlled based on hardware properties thereof, for example, based on read latencies. A memory controller according to the related art issues a command based on a fixed latency, and transmits the command to a memory device when it is confirmed that the memory device is ready. Thus, data transmission and reception efficiency with respect to a memory device including heterogeneous memories was not high. However, according to the present embodiment, a latency signal LS may be determined on the fly, and the latency signal LS may be provided to a memory device, thereby greatly increasing data transmission and reception efficiency with respect to the memory device including the heterogeneous memories MEM1 and MEM2.

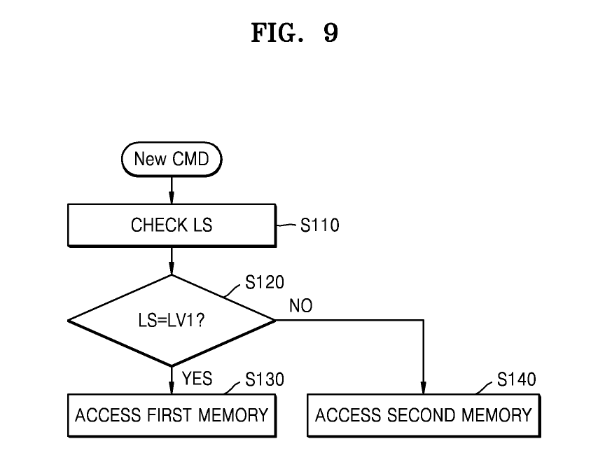

FIG. 9 is a flowchart of a method of operating a memory device according to an embodiment of the disclosure.

Referring to FIG. 9, the method of operating a memory device according to the present embodiment is directed to a method of operating a memory device including heterogeneous memories. For example, the method of operating a memory device according to the present embodiment may correspond to a method of operating the memory device 100 of FIG. 1 or FIG. 4. Details described with reference to FIGS. 1 through 8 may apply to the present embodiment, and repeated description will be omitted.

In operation S110, the memory device 100 may check a latency signal LS when a new command is received. According to the present embodiment, the memory device 100 may receive the latency signal LS with the new command According to the present embodiment, the latency signal LS may be received by the memory device 100 via some of command pins or address pins of the memory device 100.

In operation S120, the memory device 100 determines whether the latency signal LS corresponds to a first latency value LV1. Here, the first latency value LV1 may be a value corresponding to the first memory 110. As a result of the determination, when the latency signal LS corresponds to the first latency value LV1, operation S130 is performed, and when the latency signal LS does not correspond to the first latency value LV1, operation S140 is performed.

In operation S130, the memory device 100 accesses the first memory 110. In operation S140, the memory device 100 accesses the second memory 120. As described above, according to the present embodiment, as the first memory 110 or the second memory 120 may be immediately selected based on the latency signal LS, an access speed with respect to the memory device 100 may be increased.

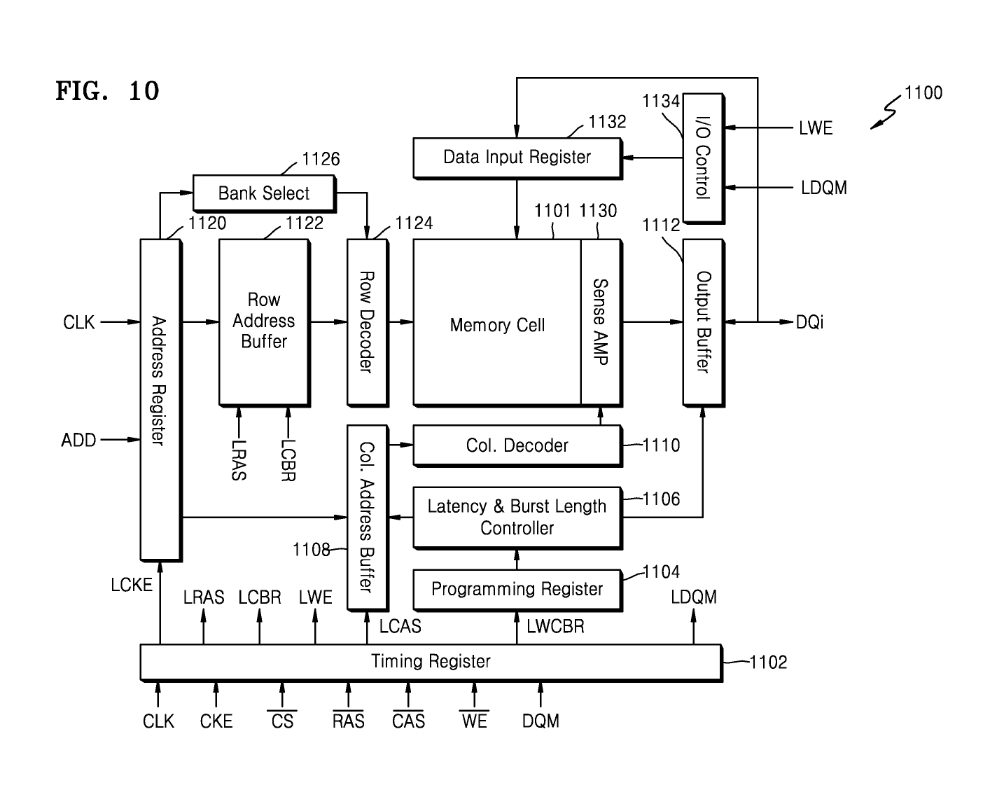

FIG. 10 is a detailed block diagram illustrating a memory device 1100 according to an embodiment of the disclosure.

Referring to FIG. 10, the memory device 1100 may include various circuit blocks used to drive a memory cell array 1101 including, for example, DRAM cells. For example, the memory device 1100 may correspond to the first memory 110 of FIG. 1 or FIG. 4. However, embodiments of the disclosure are not limited thereto, and the memory device 1100 may also correspond to the second memory 120 of FIG. 1 or FIG. 4.

A timing register 1102 may be activated when a chip selection signal CS is changed from an inactive level (e.g., logic high) to an active level (e.g., logic low). The timing register 1102 may receive a command signal such as a clock signal CLK, a clock enable signal CKE, a chip selection signal CSB, a row address strobe signal RAS/, a column address strobe signal CAS/, a write enable signal WE/, and a data input/output mask signal DQM, or the like, from the outside, and process the command signal to generate various internal command signals such as LCKE, LRAS, LCBR, LWE, LCAS, LWCBR, LDQM or the like used to control the circuit blocks.

Some internal command signals generated by the timing register 1102 are stored in a programming register 1104. For example, latency information or burst length information related to data output may be stored in the programming register 1104. The internal command signals stored in the programming register 1104 may be provided to a latency/burst length controller 1106, and the latency/burst length controller 1106 may provide a control signal, used to control a latency or a burst length of data output, to an output buffer 1112 or a column decoder 1110 via a column address buffer 1108.

An address register 1120 may receive an address signal ADD from the outside. A row address signal may be provided to a row decoder 1124 via a row address buffer 1122. Also, a column address signal may be provided to the column decoder 1110 via the column address buffer 1108. The row address buffer 1122 may respond to a refresh command LRAS or LCBR to further receive a refresh address signal generated in a refresh counter, and may provide one of a row address signal and a refresh address signal to the row decoder 1124. In addition, the address register 1120 may provide a bank signal, used to select a bank, to a bank selector 1126.

The row decoder 1124 may decode the row address signal or the refresh address signal input from the row address buffer 1122, and activate a word line of the memory cell array 1101. The column decoder 1110 may decode a column address signal and perform a selection operation on a bit line of the memory cell array 1101. For example, a column selection line may be applied to the memory device 1100 so as to perform a selection operation via the column selection line.

A sense amplifier 1130 may amplify data of a memory cell, selected by using the row decoder 1124 and the column decoder 1110, and may provide the amplified data to the output buffer 1112. Data used to record data to a data cell may be provided to the memory cell array 1101 via the data input register 1132, and the input/output controller 1134 may control a data transferring operation via the data input register 1132.

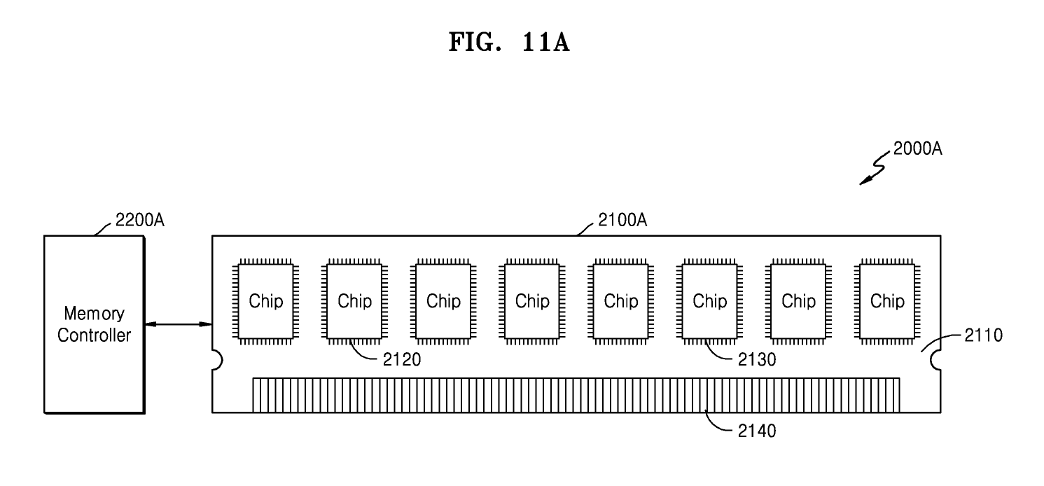

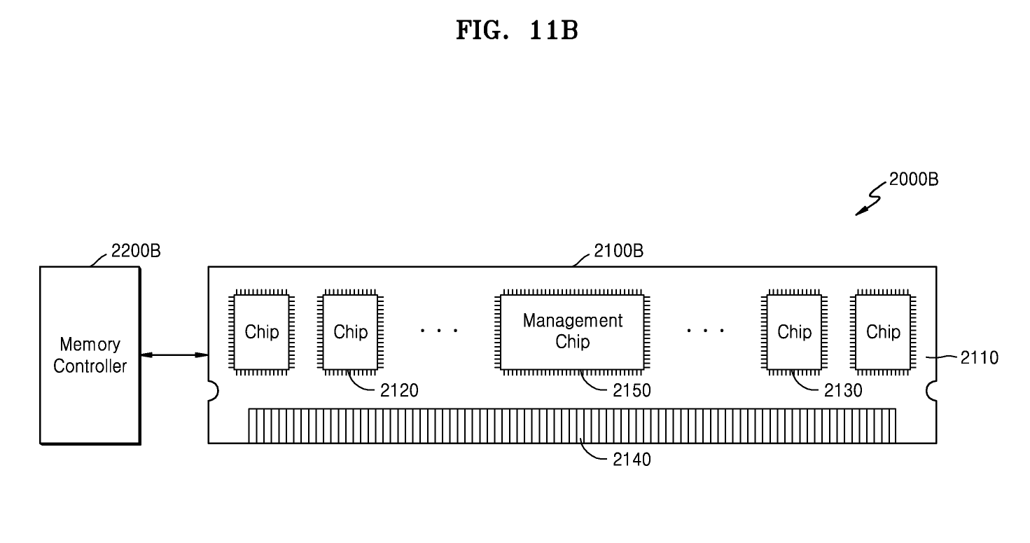

FIGS. 11A and 11B are block diagrams illustrating a memory system according to embodiments of the disclosure.

Referring to FIG. 11A, a memory system 2000A includes a memory module 2100A and a memory controller 2200A. In the memory system 2000A of FIG. 11A, although the memory controller 2200A is illustrated as being separate from the memory module 2100A, the memory controller 2200A may also be included in the memory module 2100A. The memory controller 2200A may be coupled to an upper surface or a lower surface of a print circuit board 2110, and may communicate with memory chips 2120 via conductive lines.

The memory module 2100A includes the print circuit board 2110, a plurality of first memory chips 2120, a plurality of second memory chips 2130, and a connector 2140. The plurality of first and second memory chips 2120 and 2130 may be coupled to upper and lower surfaces of the print circuit board 2110. The connector 2140 is electrically connected to the plurality of first and second memory chips 2120 and 2130 via conductive lines. Also, the connector 2140 may be connected to a slot of an external host. For example, the memory module 2100A may correspond to the memory device 100 of FIG. 1 or FIG. 4.

The plurality of first memory chips 2120 may have different hardware properties from the plurality of second memory chips 2130, and the memory module 2100A may be referred to as a hybrid memory. According to an embodiment, the plurality of first memory chips 2120 may include a volatile memory such as a DRAM cell, and may correspond to, for example, the first memory 110 of FIG. 1 or FIG. 4. The plurality of second memory chips 2130 may include a nonvolatile memory, such as a flash memory cell, and may correspond to, for example, the second memory 120 of FIG. 1 or FIG. 4. The plurality of first memory chips 2120 may store data of a computer system in the short run or temporarily like an operating memory, a cache memory or the like, and the plurality of second memory chips 2130 may be used as a backup memory. The plurality of second memory chips 2130 may be used as a storage medium that continuously stores data, and the first memory chips 2120 may be used as a buffer memory.

The memory controller 2200A may perform an operation of queuing a command or an operation of detecting a defect or an address corresponding to a command in parallel with an operation of outputting the command For example, the memory controller 2200A may correspond to the memory controller 200 of FIG. 1 or FIG. 3. In detail, the memory controller 2200A may determine a signal representing hardware properties of each of the first and second memory chips 2120 and 2130 on the fly, and transmit the signal to the memory module 2100A with a command or address. In the memory system, a DRAM interface may be applied between the memory controller 2200A and the memory module 2100A.

Meanwhile, as illustrated in FIG. 11B, a memory system 2000B may include a memory module 2100B and a memory controller 2200B, and compared to the embodiment of FIG. 11A, the memory module 2100B may further include a management chip 2150 managing a memory operation. Some of functions of the memory controller 2200B may be performed by using the management chip 2150.

While FIG. 11B illustrates an embodiment in which some of the functions of a memory controller are performed by using a memory module in the form of a load reduced dual inline memory module (LRDIMM), the embodiments of the disclosure are not limited thereto. For example, when a memory module in the form of a fully buffered dual inline memory module (FBDIMM) is applied, an advanced memory buffer (AMB) chip may be mounted as a management chip in the memory module. Also, other memory module types may be applied, and at least some of the functions of the memory controller described above may be performed by using the memory module.

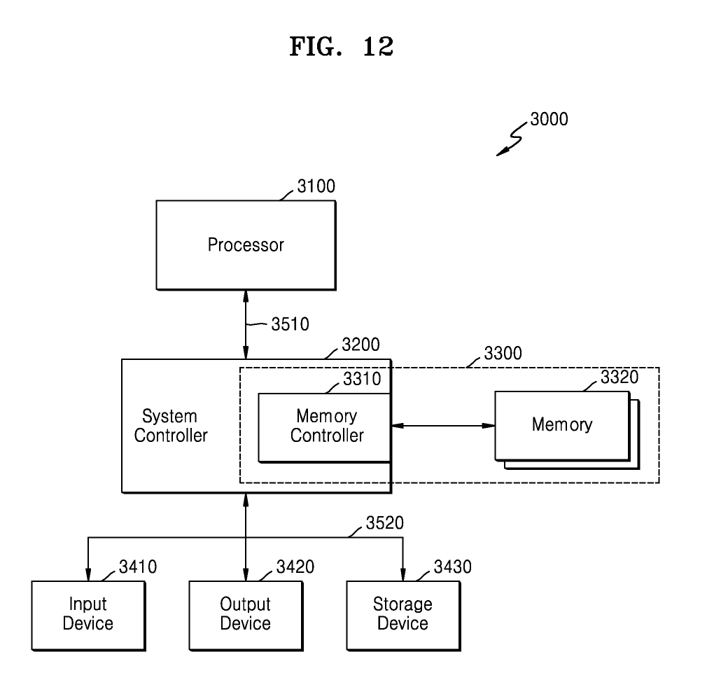

FIG. 12 is a block diagram illustrating a computing system 3000 according to an embodiment of the disclosure.

Referring to FIG. 12, the computer system 3000 includes a processor 3100, a system controller 3200, and a memory system 3300. The computer system 3000 may further include a processor bus 3510, an extension bus 3520, an input device 3410, an output device 3420, and a storage device 3430. The computer system 3000 may be, for example, a desktop computer, a notebook computer, a work station, or a handheld device.

The processor 3100 may execute various computing systems like executing predetermined software for conducting certain arithmetic operations or tasks. For example, the processor 3100 may be a microprocessor or a central processing unit (CPU). The processor 3100 may be connected to a system controller 3200 via a processor bus 3510 including an address bus, a control bus, and/or a data bus. The system controller 3200 may be connected to an extension bus 3520 such as a peripheral component interconnect (PCI) bus or the like. Accordingly, the processor 3100 may control, via the system controller 3200, at least one input device 3410 such as a keyboard or a mouse, at least one output device 3420 such as a printer or a display device, or at least one storage device 3430 such as a hard disk drive, a solid state drive, or a compact disc-read only memory (CD-ROM).

The memory system 3300 may include at least one semiconductor memory device 3320 and a memory controller 3310. The memory controller 3310 may be included in the system controller 3200. The memory controller 3310 may control the at least one semiconductor memory device 3320 to perform a command provided by the processor 3100. The at least one semiconductor memory device 3320 may store data received from the memory controller 3310 and provide the memory controller 3310 with the stored data. The at least one semiconductor memory device 3320 may convert the data received from the memory controller 3310 to generate cell data and store the cell data in a memory cell. In addition, the at least one semiconductor memory device 3320 may read the cell data from the memory cell and convert the cell data and provide the converted data to the memory controller 3310.

The at least one semiconductor memory device 3320 may include a plurality of memory chips such as a dynamic random access memory (DRAM), a static random access memory (SRAM), or a nonvolatile memory chip. In detail, the at least one semiconductor memory device 3320 may include heterogeneous memories having different hardware properties, and the memory controller 3310 may transmit, together with a command or address, a signal representing hardware properties respectively corresponding to the heterogeneous memories to the at least one semiconductor memory device 3320.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

While the disclosure has been particularly shown and described with reference to embodiments thereof, it will be understood that various changes in form and details may be made therein without departing from the spirit and scope of the following claims.

What is claimed is:

1. A memory device comprising:
a first memory having first hardware properties;
a second memory having second hardware properties different from the first hardware properties; and
a controller configured to receive a signal, representing the first or second hardware properties, with a command to select the first memory or the second memory, based on the received signal, and to control the selected first or second memory such that an operation according to the command is performed on the selected first or second memory.

2. The memory device of claim 1, wherein the first and second hardware properties comprise a latency, a memory bandwidth, or memory power consumption.

3. The memory device of claim 2, wherein:
the first hardware properties correspond to a first latency, and the second hardware properties correspond to a second latency different from the first latency, and
the signal is a latency signal representing the first latency or the second latency.

4. The memory device of claim 3, wherein the first latency is a first read latency, and the second latency is a second read latency.

5. The memory device of claim 3, further comprising:
a connector including a plurality of pins via which the latency signal and the command are received, wherein
the latency signal is received via at least one of the plurality of pins.

6. The memory device of claim 5, wherein:
the plurality of pins comprises a plurality of address pins via which an address input is received, and
the latency signal is received via at least one of the plurality of address pins.

7. The memory device of claim 5, wherein the latency signal is an n-bit signal received via n pins of the plurality of pins, and n is a natural number.

8. The memory device of claim 1, wherein the first memory is a volatile memory, and the second memory is a nonvolatile memory.

9. The memory device of claim 1, wherein the first and second memories are volatile memories.

10. The memory device of claim 1, wherein the first and second memories are nonvolatile memories.

11. A memory system comprising:
a memory device including a first memory having first hardware properties and a second memory having second hardware properties different from the first hardware properties; and
a memory controller configured to selectively control the first and second memories by transmitting a signal, representing the first or second hardware properties, and a command together to the memory device.

12. The memory system of claim 11, wherein:
the first hardware properties correspond to a first latency and the second hardware properties correspond to a second latency different from the first latency, and
the signal is a latency signal representing the first latency or the second latency.

13. The memory system of claim 12, wherein the memory controller transmits the latency signal to the memory device as a portion of an address input or a command input.

14. The memory system of claim 12, wherein:
the memory device further comprises a connector including a plurality of pins via which the latency signal and the command are received, and
the latency signal is transmitted via at least one of the plurality of pins.

15. The memory system of claim 14, wherein:
the plurality of pins comprises a plurality of address pins via which an address input is received, and
the latency signal is received via at least one of the plurality of address pins.

16. A memory system comprising:
a memory device comprising first and second memories, the first memory has a first access latency and the second memory has a second access latency that differs from the first access latency; and
a memory controller that distinguishes the first memory from the second memory based upon the first and second latencies.

17. The memory system of claim 16, wherein the memory controller:
acquires access to the first memory by communicating an indicator of the first access latency to the memory device, and
acquires access to the second memory by communicating an indicator of the second access latency to the memory device.

18. The memory system of claim 17, wherein the indicator of each of the first and second access latencies identifies a specific value of latency time required to access the respective first and second memories.

19. The memory system of claim 16, wherein the memory controller selects, based upon the first and second latencies, an order of communicating, to the memory device, an access request pertaining to each of the first and second memories so as to minimize the period between which the first and second memories provide data, for access by the memory controller, in response to the access requests.

20. The memory system of claim 16, wherein the memory controller controls, based upon the first and second latencies, the timing of communicating, to the memory device, an access request pertaining to each of the first and second memories so as to prevent the first and second memories from providing data, for access by the memory controller, at the same time.
